(19) United States
(12) Patent Application Publication
(10) Pub. No.: US 2026/0116651 A1
(43) Pub. Date: Apr. 30, 2026

(54) METHODS OF USING A SECURABLE RECYCLING RECEPTACLE FOR COMPLIANT DISPOSAL OF REGULATED PRODUCTS

(71) Applicant: Green For Green PBC, Fort Collins, CO (US)

(72) Inventor: Shawn Naughton, Fort Collins, CO (US)

(21) Appl. No.: 19/378,722

(22) Filed: Nov. 4, 2025

Related U.S. Application Data
(62) Division of application No. 18/323,569, filed on May 25, 2023.
(60) Provisional application No. 63/346,505, filed on May 27, 2022.

(51) Int. Cl. B65F 1/16; B65F 1/02; B65F 1/14

(52) U.S. Cl. CPC B65F 1/1615; B65F 1/02; B65F 1/1484; B65F 1/1607; B65F 1/163; B65F 2210/148

(57) ABSTRACT

The present disclosure relates to securable recycling receptacles. In one example, a securable recycling receptacle includes a housing defining a housing cavity, a lid coupled to the housing by a hinge that is coupled to a first side of the lid, an opening defined in a top surface of the lid, and a locking mechanism coupled to a second side of the lid. A size of the opening is about a size of a regulated recyclable and the size of the opening limits access to the housing cavity. The locking mechanism secures the lid to the housing to prevent opening the lid to access the housing cavity. The securable recycling receptacle is configured for recycling regulated recyclables in compliance with laws or regulations related to disposal of the regulated recyclables.

### CROSS REFERENCE TO RELATED APPLICATIONS

The present application is a divisional application of U.S. patent application Ser. No. 18/323,569, entitled “Securable Recycling Receptacle for Compliant Disposal of Regulated Products,” filed May 25, 2023, which claims the benefit of priority to U.S. Provisional Patent Application No. 63/346,505 , entitled “Securable Recycling Receptacle,” filed May 27, 2022, the entireties of both of which are hereby incorporated by reference herein for all purposes.

### TECHNICAL FIELD

The technology described herein relates generally to a securable recycling receptacle, specifically for use in disposing of regulated products, such as cannabis-related products, in a manner that is compliant with existing laws and regulations.

### BACKGROUND

The marijuana or cannabis industry is a growing industry, as marijuana becomes legalized in more states throughout the United States. However, marijuana currently remains illegal under federal law and is highly regulated by state governments where it is legalized. Such laws and regulations include controlling amounts that can be grown, sold, or carried, as well as controlling its cultivation, retail, and disposal. For example, the Marijuana Enforcement Division (MED) in Colorado has instituted various regulations related to the disposal of cannabis containers and other related products. For example, the MED Code of Colorado Regulations sets forth rules that establish specific conditions under which regulated marijuana businesses are permitted to collect marijuana consumer waste for purposes of reuse and recycling. Currently, there are no recycling receptacles that facilitate compliance with such regulations.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes a securable recycling receptacle. Embodiments of the present disclosure may include a securable recycling receptacle including a housing defining a housing cavity, a lid coupled to the housing by a hinge that is coupled to a first side of the lid, and a locking mechanism coupled to a second side of the lid. The locking mechanism may secure the lid to the housing to prevent opening the lid to access the housing cavity. An opening may be defined in a top surface of the lid and may have a size that is about a size of a regulated recyclable and the size of the opening may limit access to the housing cavity. The securable recycling receptacle may be configured for recycling regulated recyclables in compliance with laws or regulations related to disposal of the regulated recyclables.

Additionally or separately, the size of the regulated recyclable may be compatible with legal limits on amounts of a regulated substance contained therein. Additionally or separately, the regulated recyclable may be a cannabis container. Additionally or separately, the opening may have a four inch diameter. Additionally or separately, the first side of the lid may be adjacent to the second side of the lid. Additionally or separately, the locking mechanism may include a lock configured to receive a universal key. Additionally or separately, the securable recycling receptacle may include one or more signage holders coupled to the top surface of the lid. Additionally or separately, the securable recycling receptacle may include a plurality of regulated recyclables positioned within the housing cavity. Additionally or separately, the size of the opening may allow passage of a maximum-sized regulated container therethrough without allowing trash that is larger than the maximum-sized regulated container from passing therethrough. Additionally or separately, the maximum-sized regulated container is a maximum-sized cannabis container based on government regulations on legal cannabis amounts for sale or possession. Additionally or separately, the hinge may be coupled to a rear wall of the housing to couple the lid to the rear wall, and the locking mechanism may be coupled to a sidewall of the housing to secure the lid to the housing in a manner that is in compliance with the laws or regulations. Additionally or separately, the opening may include an opening edge trim coupled to an edge of the opening to soften the edge.

Other examples or embodiments of the present disclosure may include a securable recycling receptacle that includes a housing defining a housing cavity, a hinge coupled to a rear wall of the housing, a lid coupled to the housing by the hinge, and a locking mechanism coupled to a sidewall of the housing. The locking mechanism may secure the lid to the housing to prevent the lid from opening. An opening may be defined within the lid. The opening may be sized to allow passage of a maximum-sized regulated container therethrough without allowing trash that is larger than the maximum-sized regulated container from passing therethrough.

Additional examples or embodiments of the present disclosure may include a cannabis consumer waste recycling receptacle including a housing defining a housing cavity, a lid coupled to the housing, and a locking mechanism coupled to the housing and to the lid. The locking mechanism may secure the lid to the housing to prevent the lid from opening to access cannabis consumer waste stored in the housing cavity. An opening may be defined within the lid. The opening may be slightly greater than or no greater than a maximum-sized cannabis container to allow passage of the maximum-sized cannabis container therethrough while limiting access to the housing cavity. The cannabis consumer waste recycling receptacle may be compliant with government regulations for recycling cannabis consumer waste.

Further examples or embodiments of the present disclosure may include a method of manufacturing a securable recycling receptacle. The method may include defining an opening in a top wall of a receptacle lid. The opening may be sized to be slightly greater than or no greater than a size of a regulated container that is compatible with legal limits on amounts of a regulated substance contained therein. The receptacle lid may be coupled to a receptacle housing by a hinge that is coupled to a rear wall of the housing and a lid rear wall. The method may further include coupling a locking mechanism to the securable recycling receptacle on a side that is adjacent to the rear wall of the housing.

Additional examples or embodiments of the present disclosure may include a method of recycling regulated recyclables. The method may include locating a lid opening defined in a top surface of a lid of a securable recycling receptacle. The securable recycling receptacle may include a housing defining a housing cavity configured to receive a regulated recyclable. A first side of the lid may be coupled to a first wall of the housing, and a locking mechanism may be coupled to a second side of the lid and a second wall of the housing to secure the lid to the housing and to prevent unauthorized access to the regulated recyclable when the regulated recyclable is stored in the housing cavity. The method may further include discarding the regulated recyclable through the lid opening and into the housing cavity, wherein the regulated recyclable was used in association with a regulated substance.

Additionally or separately, the regulated recyclable may be a cannabis container and the method may be compliant with government regulations for recycling cannabis consumer waste. Additionally or separately, the regulated substance may be cannabis and the lid opening may be slightly greater than or no greater than a maximum-sized cannabis container to allow passage of the maximum-sized cannabis container therethrough while limiting access to the housing cavity.

Further examples or embodiments of the present disclosure may include a method of accessing regulated recyclables stored in a securable recycling receptacle. The method may include unfastening a lock coupled to a housing of the securable recycling receptacle, wherein the lock secures a lid to the housing, the housing defines a housing cavity storing the regulated recyclables, and the lid includes a lid opening on a top surface of the lid that allows limited access to the housing cavity. The method may include positioning the lid in an open position and removing the regulated recyclables from the housing cavity for recycling at a regulation-compliant recycling facility.

Additionally or separately, the lid may be coupled to a first wall of the housing by a hinge and the lock may be coupled to a second wall of the housing. Additionally or separately, unfastening the lock may include inserting a universal key inside the lock and turning the universal key. Additionally or separately, the regulated recyclables may include cannabis consumer waste and the lid opening may be sized to fit a maximum-sized cannabis container or a maximum-sized cannabis-related product. Additionally or separately, the lock may be coupled to a locking mechanism. The locking mechanism may include a latch and a locking eye. One of the latch and locking eye may be coupled to the housing. The latch may be coupled to the locking eye. The lock may be positioned through a locking eye aperture of the locking eye. The method may further include removing the lock from the locking eye aperture after unfastening the lock, and uncoupling the latch from the locking eye before positioning the lid in the open position.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is an isometric side view of an exemplary securable recycling receptacle.

FIG. 2 is a front elevation view of the securable recycling receptacle of FIG. 1.

FIG. 3 is a rear elevation view of the securable recycling receptacle of FIG. 1.

FIG. 4 is a top plan view of the securable recycling receptacle of FIG. 1.

FIG. 5 is a top isometric view of the securable recycling receptacle of FIG. 1.

FIG. 6 is a zoomed-in view of the locking mechanism of the securable recycling receptacle of FIG. 1.

FIG. 7 is a flow chart illustrating an exemplary method for manufacturing a disclosed securable recycling receptacle.

FIG. 8 is a flow chart illustrating a method of using a disclosed securable recycling receptacle.

FIG. 9 is a flow chart illustrating an exemplary method for accessing regulated recyclables in a disclosed securable recycling receptacle.

### DETAILED DESCRIPTION

The disclosed technology includes securable recycling receptacles. In several embodiments, disclosed securable recycling receptacles allow for the collection of recyclables with limited access to the receptacle's contents. For example, certain recyclables or recycling processes may be controlled or regulated, such as those associated with regulated or controlled substances (such recyclables referred to herein as “regulated recyclables”). In several embodiments, disclosed securable recycling receptacles receive regulated recyclables and provide limited access to the collected regulated recyclables stored therein. As an example, cannabis is a substance that is regulated by state government agencies. Such agencies have issued certain rules governing the recycling of cannabis consumer waste, which includes cannabis consumer packaging or containers and/or cannabis-related products (e.g., lithium ion batteries, vape pens or vaporizers, cannabis cartridges, etc.). In several embodiments, disclosed securable recycling receptacles are useful in the cannabis industry for disposing of cannabis consumer waste.

Conventional recycling receptacles do not have limited or restricted access and do not include, for example, a locking or securing mechanism to limit or restrict access to recyclables disposed of therein. Such conventional recycling receptacles fail to comply with government regulations regarding the recycling of regulated recyclables, such as, for example, cannabis consumer packaging.

In several embodiments, disclosed securable recycling receptacles satisfy government requirements for collection, reuse, and recycling of cannabis consumer packaging and waste. As an example, the Colorado MED requires cannabis retailers that collect cannabis consumer waste to utilize receptacles that are locked, sealed, and designed to require a key or specialized tools in order to open and access the contents of the receptacle. In several embodiments, securable recycling receptacles satisfy the Colorado MED requirements for marijuana consumer waste recycling.

In several embodiments, the securable recycling receptacle includes a housing, a lid, a lid opening, and a securing or locking mechanism. The lid opening may be defined in a top surface of the lid. The lid opening may be sized to allow the largest regulated recyclable to pass therethrough while restricting access to the receptacle's contents and limiting trash that can be disposed of into the receptacle. For example, there may be limits on an amount of a regulated substance that can be sold and carried. Such size limits may dictate a maximum size for containers storing the regulated substance. For example, the maximum amount of cannabis that can be sold in Colorado is 1 ounce. Common containers for carrying 1 ounce of cannabis have a diameter of 3.5″ and a height of 3″. The size of such containers may vary. For example, some cannabis containers are 3.75″ in diameter with a height of 4″. The lid opening may be sized to allow such cannabis containers to pass therethrough.

The lid may be coupled to the housing by a hinge. The securing or locking mechanism may secure the lid to the housing. The securing or locking mechanism may be positioned on a side of the housing that does not include the hinge. The securing or locking mechanism may prevent unauthorized users from opening the lid thereby restricting access to the contents of the securable recycling receptacle. The securable recycling receptacle may be made of various materials, including, for example, plastic or metal.

The securable recycling receptacle may be used by marijuana or cannabis dispensaries to collect recyclable cannabis consumer waste for recycling. Recyclables that may be collected in the securable recycling receptacle may include glass, metal, plastic, compostable material, and the like.

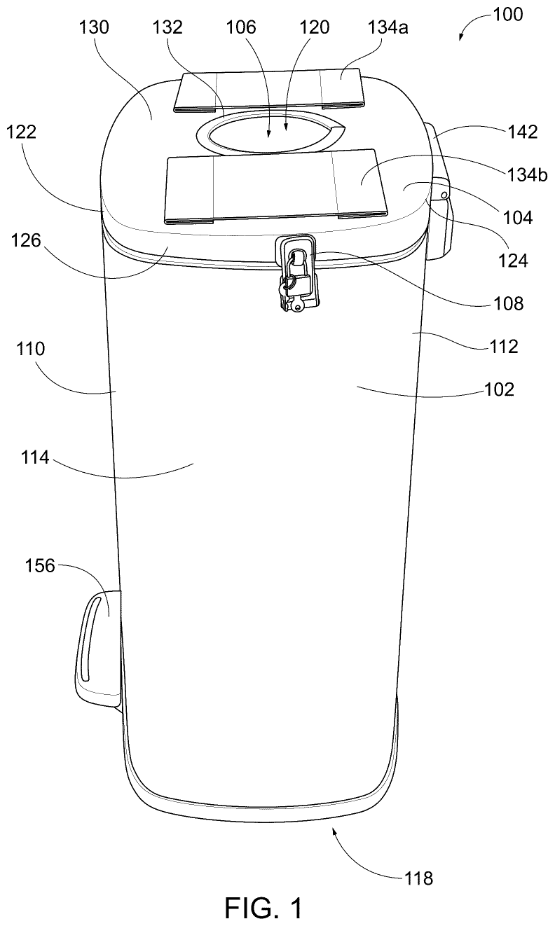

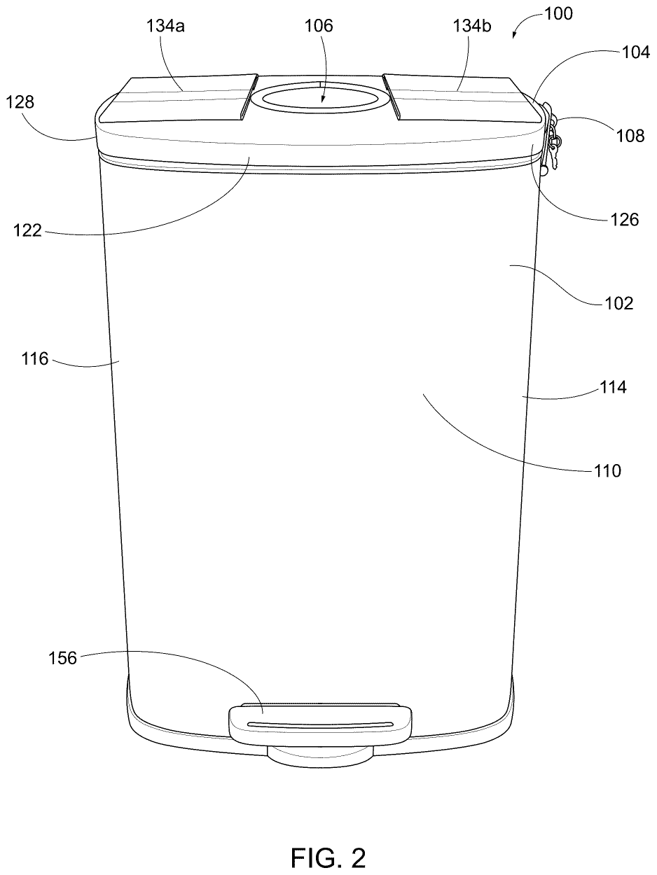

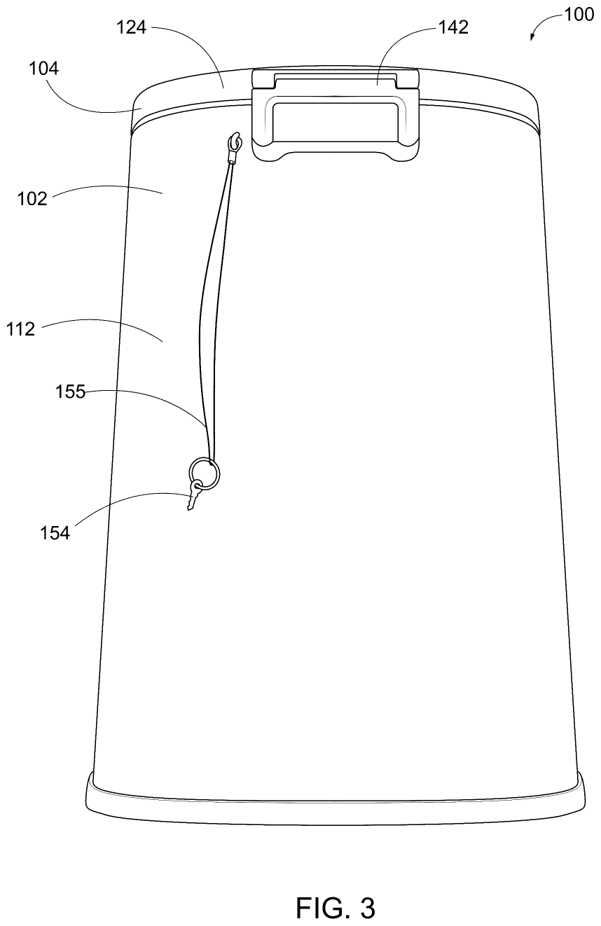

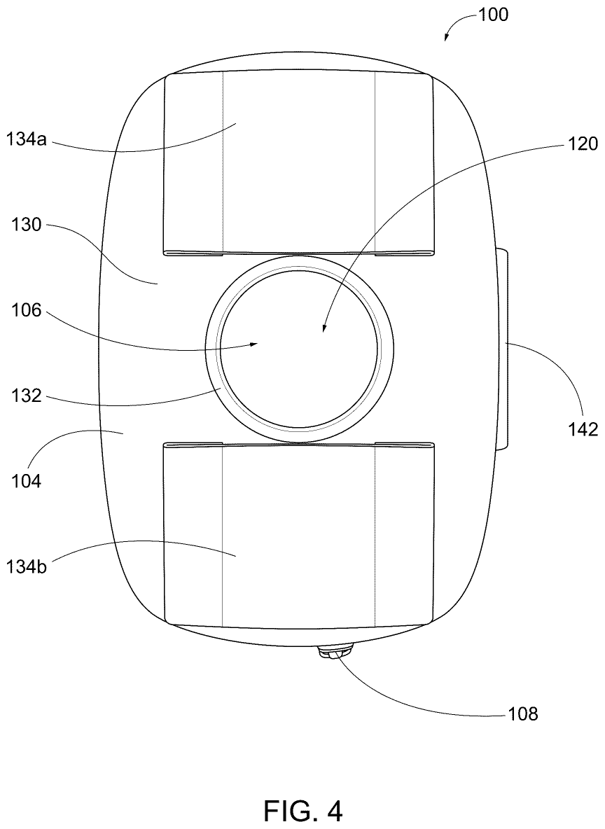

Turning to the figures, securable recycling receptacles of the present disclosure will now be discussed in more detail. FIG. 1 is an isometric side view of an exemplary securable recycling receptacle. FIG. 2 is a front elevation view of the securable recycling receptacle of FIG. 1. FIG. 3 is a rear elevation view of the securable recycling receptacle of FIG. 1. FIG. 4 is a top plan view of the securable recycling receptacle of FIG. 1. As shown in FIGS. 1-4, the securable recycling receptacle 100 includes a housing 102, a lid 104, a lid opening 106, and a securing or locking mechanism 108. The housing 102 may be any conventional recycling or trash receptacle housing having a front wall 110, rear wall 112, right and left sidewalls 114, 116, respectively, and a base 118 that together define a housing cavity 120. The housing 102 may be sized to receive numerous regulated recyclables to facilitate bulk collection and recycling. For example, an exemplary housing 102 may have a width of 17″, a length of 14.4″, and a height of 24.8″. Such housing dimensions may be varied based on a desired amount of regulated recyclables to be collected in the securable recycling receptacle 100. The housing 102 may be made of a durable material, such as, for example, plastic, stainless steel, and the like. The lid 104 may be any conventional recycling or trash receptacle lid. For example, the lid 104 may have a size and shape compatible with a conventional recycling or trash receptacle housing. As shown, the lid 104 has a size and shape compatible with the housing 102. The lid 104 may include a lid front wall 122, a lid rear wall 124, a lid right sidewall 126, a lid left sidewall 128, and a lid top wall 130.

The lid opening 106 may be defined in the lid 104, e.g., in the lid top wall 130, as shown. The lid opening 106 may have a circular or oval shape. For example, a circular shape may be easier to manufacture and seal. As shown, the lid opening 106 may include an opening edge trim or seal strip 132 to cover any sharp edges and prevent users from cutting themselves on the opening edge. The opening edge trim 132 may be made of rubber or soft plastic or another material for softening the opening edge. While a circular shape is depicted, other shapes are contemplated for the lid opening 106, such as, for example, a square or rectangular shape, triangular shape, or the like.

The lid opening 106 may be selectively sized to receive particular regulated recyclables, such as those that are monitored, regulated, or otherwise controlled by a U.S. government agency or body. For example, the securable recycling receptacle 100 may be used to recycle containers or products related to regulated or controlled substances, such as marijuana or cannabis. Such regulated or controlled substances may only be sold or carried in certain quantities (e.g., as regulated by U.S. state governments) and have corresponding containers sized to fit such quantities (herein referred to as “regulated containers”). For example, current U.S. state regulations restrict the sale of cannabis to 1 or 2 ounces (depending on the state, for example). Current containers used for these quantities have a diameter of about 3.5″ to about 3.75″ and a height of about 3″ to about 4″. The size of such containers may vary. The lid opening 106 may be sized to fit the largest sized cannabis container, e.g., a 4″ wide container. For example, the lid opening 106 may have a circular shape with a 4″ diameter. The diameter size may be varied based on the regulated recyclables being collected, e.g., based on the type and size of selected regulated recyclables. For example, the circular lid opening may have a diameter that is smaller or larger than 4″ based on maximum regulated container sizes.

The lid opening 106 may be sized to restrict or limit access to the housing cavity 120. For example, the lid opening 106 may be no greater than or about a size of (e.g., an equivalent size as, or slightly greater than (e.g., a couple inches or less, a couple centimeters or less, a couple millimeters or less, etc.)) the largest sized regulated container (e.g., the largest sized cannabis container) to facilitate disposal of regulated containers while limiting access to the housing cavity 120. For example, if the largest sized cannabis container has a diameter of 3.5″, then the lid opening 106 may be about the size of the 3.5″ diameter container, e.g., the lid opening 106 may have a diameter between 3.5″ to 3.75″ or 4″. As another example, if the largest sized cannabis container has a diameter of 3.75″, then the lid opening 106 may be about the size of the 3.75″ diameter container, e.g., the lid opening 106 may have a diameter between 3.75″ to 4″. As yet another example, if the largest sized cannabis container has a height of 3″, then the lid opening 106 may be about the size of the 3″ tall container, e.g., the lid opening 106 may have a diameter between 3″ to 3.5,″ 3.75,″ or 4″. As a further example, if the largest sized cannabis container has a height of 4″, then the lid opening 106 may be about the size of the 4″ tall container, e.g., the lid opening 106 may have a diameter between 4″ to 4.25″, 4.5″, or 4.75″. The lid opening 106 may be sized to prevent objects larger than the largest sized regulated container from passing therethrough. The lid opening 106 may be sized to prevent or limit an average adult and/or an average child or teenager from sticking his/her hand, wrist, and/or arm inside. In other words, the lid opening 106 may be sized to prevent an object the size of an average adult hand from passing therethrough. The lid opening 106 may be sized to prevent trash or garbage or other non-recyclables from passing therethrough and being disposed of in the securable recycling receptacle 100. For example, a diameter size of 3.5″ to 4″ for a circular lid opening 106 may prevent bags of garbage or large crumpled trash from being deposited into the securable recycling receptacle 100. Preventing non-recyclables from entering the receptacle may facilitate the sorting process.

As shown, the lid opening 106 is positioned centrally on the lid top wall 130, with equal distance between the lid opening 106 and the lid right sidewall 126 and lid left sidewall 128 and between the lid front wall 122 and lid rear wall 124. It is contemplated that the lid opening 106 may be positioned elsewhere on the lid top wall 130, e.g., closer to one or more of the lid walls 122, 124, 126, 128.

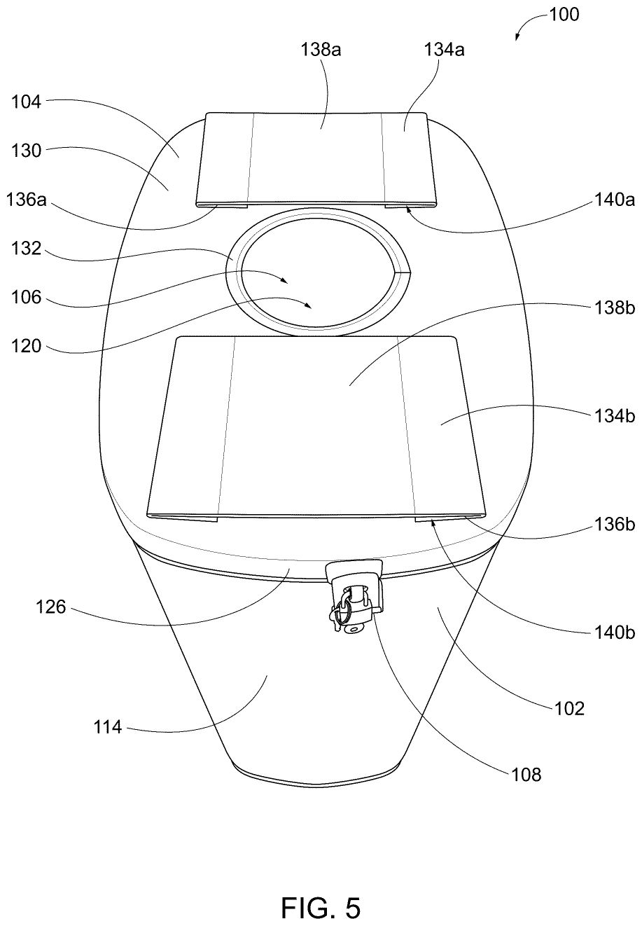

FIG. 5 is a top isometric view of the securable recycling receptacle of FIG. 1. As shown, the lid top wall 130 may include signage holders 134a, b. The signage holders 134a, b may include bottom surfaces 136a, b and top surfaces 138a, b. The signage holders 134a, b may include signage holder openings 140a, b defined between the bottom surfaces 136a, b and top surfaces 138a, b. As shown, the signage holder openings 140a, b are slits. The signage holder openings 140a, b may receive signage on either end of the signage holders 134a, b, facilitating the placement and removal of signage therein. The signage holder top surface 138a, b may be made of a transparent or semitransparent material, such as, for example, plastic. In the depicted embodiment, the signage holders 134a, b are made of a single piece of plastic that is folded on opposing sides to form the bottom surfaces 136a, b and the signage holder openings 140a, b. As shown, the bottom surfaces 136a, b are incomplete surfaces with a gap spacing apart two portions of the bottom surfaces 136a, b. As shown, the signage holders 134a, b are square or rectangular shaped, e.g., to hold conventional advertising or promotional materials. For example, the signage holders 134a, b may be shaped to hold 5″×7″ cards or signage.

The signage holders 134a, b may be coupled to the lid top wall 130. As shown, the bottom surfaces 136a, b are coupled to the lid top wall 130. In the depicted embodiment, the signage holders 134a, b are positioned on the lid top wall 130 on opposing sides of the lid opening 106; however, other positioning of the signage holders 134a, b is contemplated. For example, the signage holders 134a, b may be positioned on the housing 102. While two signage holders 134a, b are depicted, more or less are contemplated. In some embodiments, the signage holders 134a, b are omitted. Signage, such as advertising, promotional, or informational materials (e.g., related to the regulated products disposed of in the securable recycling receptacle 100), may be inserted in the signage holder openings 140a, b and may be visible through the transparent or semitransparent signage holder top surface 138a, b. The signage holders 134a, b allow signage to be interchangeable on the securable recycling receptacle 100. This ability to quickly change signage allows customization of the securable recycling receptacle 100 by the owner or user of the securable recycling receptacle 100. For example, a dispensary may use the signage holders 134a, b for its own point-of-sale signage. The positioning of the signage holders 134a, b on the lid top wall 130 may increase visibility of the signage positioned therein, which may be particularly beneficial for signage related to compliant disposal of regulated recyclables. For example, users searching for the lid opening 106 may look in the vicinity of the signage holders 134a, b, which may increase the likelihood of users viewing the signage than if the signage holders 134a, b were positioned on a different surface of the securable recycling receptacle 100 (e.g., on the housing 102).

In several embodiments, the lid 104 is hingedly coupled to the housing 102. For example, FIGS. 1 and 3 show an exemplary hinge 142 coupling the lid 104 to the housing 102. The hinge 142 may be any conventional hinge. As shown, the hinge 142 couples the lid rear wall 124 to the rear wall 112 of the housing 102 such that the lid 104 opens by separating the lid front wall 122 from the front wall 110 of the housing 102, thereby providing access to the housing cavity 120.

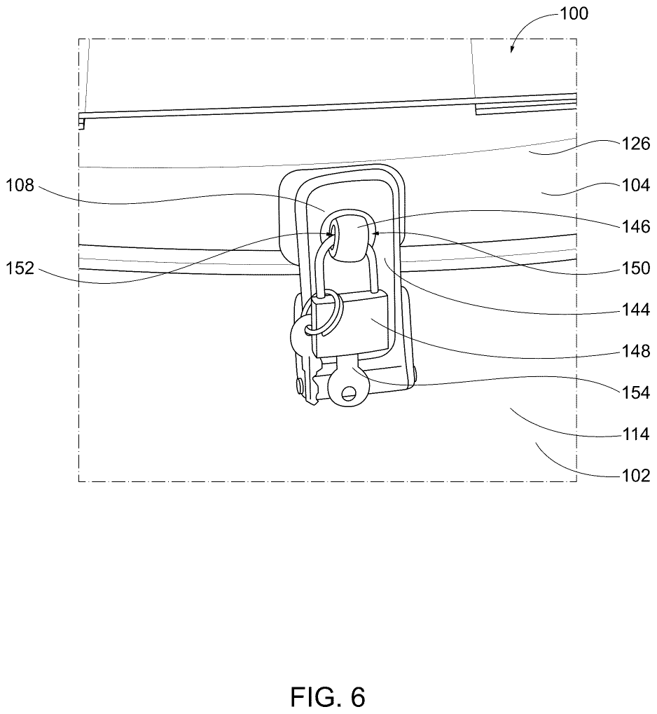

In several embodiments, the lid 104 is secured or locked to the housing 102 by a securing or locking mechanism. The securing or locking mechanism may be any conventional locking mechanism that allows multiple authorized users access. For example, FIG. 6 is a close-up view of an exemplary securing or locking mechanism 108. The locking mechanism 108 may include a hasp, latch, or bracket 144 and a locking eye or loop 146. A pad lock, pin, or other lock 148 may be inserted into the locking eye 146 to lock the locking mechanism 108. For example, the lock 148 may be inserted into a locking eye aperture 152 of the locking eye 146. As shown, the lock 148 may hang at least partially below the locking eye 146 and at least partially below the lid 104. The lock 148 may be a key lock or combination lock. As an example, the lock 148 may be configured to receive a key 154, such as a universal key. Universal key access for opening and securing the securable recycling receptacle 100 may allow authorized operators access to the contents of the securable recycling receptacle 100. For example, authorized operators may include cannabis dispensary owners or employees, government authorities, and recycling service providers. As shown in FIG. 3, the key 154 may be coupled to the securable recycling receptacle 100 by a tether 155. As shown, the tether 155 may be fixedly coupled to the rear wall 112 of the housing 102 adjacent to or proximate to the hinge 142 and between the hinge 142 and the right sidewall 114 (or the sidewall that includes the locking mechanism 108). The key 154 may be coupled to a distal end of the tether 155. The tether 155 may have a length that permits movement of the key 154 to the locking mechanism 108 to open or lock the locking mechanism 108. For example, the key 154 may be inserted into the lock 148 and remain tethered to the rear wall 112 via the tether 155. The key 154 may be inserted into the lock 148 in a position below the lid 104. The tether 155 may therefore have a length that permits movement of the key 154 to a position below the lid 104.

In several embodiments, the locking mechanism 108 is positioned on a side of the securable recycling receptacle 100. The locking mechanism 108 may be positioned on a side of the securable recycling receptacle 100 that does not include the hinge 142. For example, the locking mechanism 108 may be positioned on a side of the securable recycling receptacle 100 that is adjacent to or perpendicular to a side that includes the hinge 142. In the depicted embodiment, the locking mechanism 108 is positioned on the lid right sidewall 126 and right sidewall 114 of the housing 102 (e.g., the sides adjacent to or perpendicular to the lid rear wall 124 and the rear wall 112 of the housing 102, respectively). For example, the latch 144 may be positioned on the right sidewall 114 and the locking eye 146 may be positioned on the lid right sidewall 126. The lid 104 may be secured to the housing 102 by coupling the latch 144 to the locking eye 146 and inserting the lock 148 through the locking eye 146. For example, the locking eye 146 may be received within the latch aperture 150 of the latch 144 and the lock 148 may be received through the locking eye aperture 152.

While a single locking mechanism 108 is depicted, additional locking mechanisms may be included. For example, if the hinge 142 is omitted, the lid 104 may be secured to the housing 102 by two or more locking mechanisms. For example, the locking mechanisms may be positioned on opposing sides of the securable recycling receptacle 100, e.g., front and rear sides or left and ride sides. The single locking mechanism 108 may reduce manufacturing and material costs and provide quicker access to the regulated recyclables stored in the securable recycling receptacle 100 while providing an effective seal for preventing unauthorized access to the securable recycling receptacle 100 contents. While the depicted locking mechanism 108 is positioned on the lid right sidewall 126 and right sidewall 114 of the housing 102, it is contemplated that the locking mechanism 108 may be positioned on the lid left sidewall 128 and left sidewall 116 of the housing 102 or on the lid front wall 122 and front wall 110 of the housing 102. Positioning the locking mechanism 108 on the sidewalls (as opposed to the front wall 110) may be aesthetically advantageous, allowing unobstructed branding on the front wall 110. Positioning the locking mechanism 108 on the sidewalls may provide increased security (e.g., as opposed to positioning the locking mechanism 108 on the rear wall 112 by the hinge 142), preventing access to the securable recycling receptacle 100 housing cavity 120 and its contents.

As shown in FIGS. 1-2, the securable recycling receptacle 100 may include a foot pedal 156. The foot pedal 156 may be any conventional foot pedal to activate the hinge 142 to open the lid 104. In several embodiments, the locking mechanism 108 prevents the foot pedal 156 from opening the lid 104. When the locking mechanism 108 is unlocked (e.g., by removing the lock 148 and releasing the latch 144 from the locking eye 146), the foot pedal 156 can be activated to open the lid 104. The foot pedal 156 may facilitate hands-free access to the securable recycling receptacle 100 contents. It is contemplated that the foot pedal 156 may be omitted form the securable recycling receptacle 100 and the contents accessed by manually opening the lid 104.

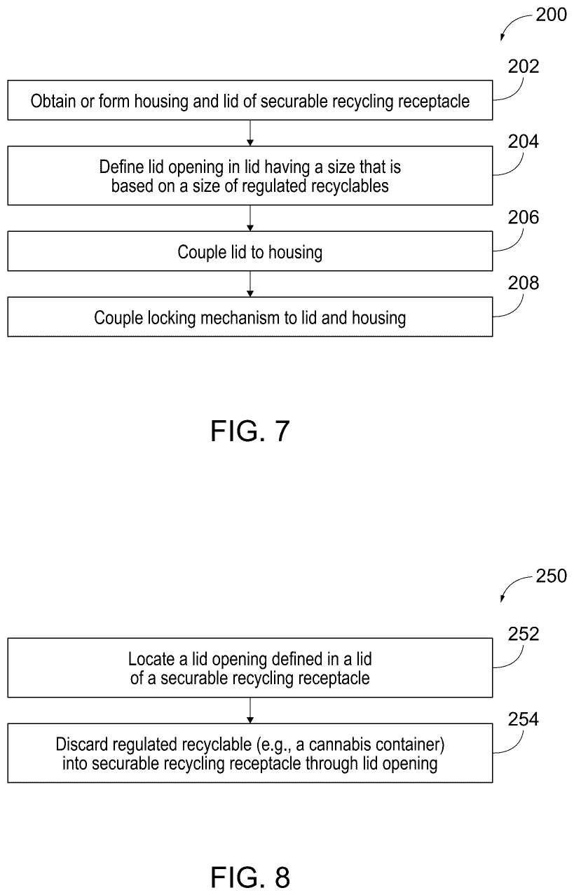

The securable recycling receptacle 100 may be constructed by various methods. FIG. 7 is a flow chart illustrating an exemplary method for manufacturing a disclosed securable recycling receptacle 100. As shown, the method 200 begins with operation 202 and the housing 102 and lid 104 are obtained or formed. In some embodiments, one or both of the housing 102 and lid 104 are obtained from a second manufacturer, e.g., a manufacturer of conventional trash or recycling receptacles. In other embodiments, the housing 102 and lid 104 are manufactured by the same manufacturer constructing the securable recycling receptacle 100. The housing 102 and the lid 104 may be formed by conventional means, such as, for example, stamping, molding, welding, and the like.

After operation 202, the method 200 may proceed to operation 204 and the lid opening 106 may be defined in the lid 104. The lid opening 106 may be formed by cutting a shape (e.g., a circular shape) in the lid top wall 130. For example, the lid opening 106 may be defined centrally in the lid top wall 130. The lid opening 106 may be formed by a hydraulic punch press, drilling, laser cutting, and the like. The lid opening 106 may be sized to conform to a size of regulated recyclables, as described in detail above. The opening edge trim 132 may be coupled to an edge of the lid 104 formed by the lid opening 106.

After operation 204, the method 200 may proceed to operation 206 and the lid 104 may be coupled to the housing 102. For example, the lid 104 may be coupled to the housing 102 by the hinge 142. For example, the hinge 142 may be coupled to the lid rear wall 124 and the rear wall 112 of the housing 102. The hinge 142 may be coupled to the housing 102 and lid 104 by conventional fasteners (e.g., screws, bolts, etc.).

After operation 206, the method 200 may proceed to operation 208 and the locking mechanism 108 may be coupled to the housing 102 and the lid 104. The locking mechanism 108 may be partially coupled to the lid 104 and partially coupled to the housing 102. The locking mechanism 108 may be coupled to a side of the securable recycling receptacle 100 that is adjacent to or perpendicular to the side that the hinge 142 is coupled to. For example, the locking mechanism 108 may be coupled to the lid right sidewall 126 and right sidewall 114 of the housing 102. For example, the latch 144 may be coupled to the right sidewall 114 (e.g., by drilling, screwing, etc.) and the locking eye 146 may be coupled to the lid right sidewall 126 (e.g., by drilling, screwing, etc.). It is contemplated that one or more of the manufacturing steps may be omitted. For example, where the hinge 142 is omitted, the step of coupling the lid 104 to the housing 102 by the hinge 142 may also be omitted. As another example, the housing 102 and lid 104 may already be formed and attached, such that the step of coupling the housing 102 and the lid 104 may be omitted. The securable recycling receptacle 100 may be manufactured for use in the cannabis industry.

FIG. 8 is a flow chart illustrating a method of using a disclosed securable recycling receptacle 100. The method 250 begins with operation 252 and a user locates the lid opening 106 defined in the lid 104 of the securable recycling receptacle 100. The user may locate the lid opening 106 on the lid top wall 130 of the secured lid 104.

After operation 252, the method 250 may proceed to operation 254 and the user may discard one or more regulated recyclables into the securable recycling receptacle 100 through the lid opening 106. As discussed above, the user may be able to discard the one or more regulated recyclables through the lid opening 106 into the housing cavity 120 without having access to the housing cavity 120 contents. For example, the user may be able to place a regulated recyclable into the lid opening 106 but may not be able to fit his or her hand or arm through the lid opening 106. The user is also unable to open the secured lid 104 if the user is an unauthorized user (e.g., a cannabis customer). As discussed above, the one or more regulated recyclables may include a cannabis container or other cannabis-related product or recyclable. Without having this access to a disclosed securable recycling receptacle 100, the user may not be able to recycle the one or more regulated recyclables, as various conventional recycling facilities will not accept certain regulated recyclables (e.g., cannabis containers may be considered drug contraband that such facilities cannot accept due to federal prohibition).

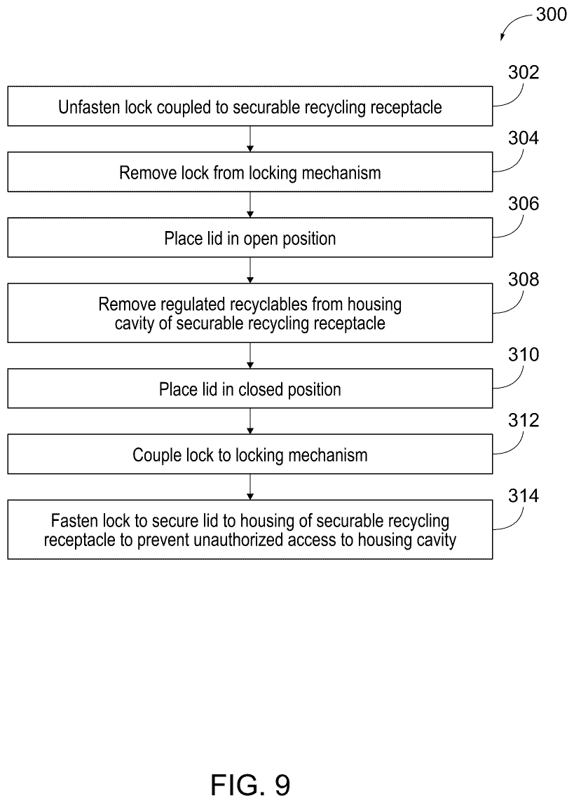

In several embodiments, the securable recycling receptacle 100 provides restricted access to the housing cavity 120 and its contents. FIG. 9 is a flow chart illustrating an exemplary method for accessing regulated recyclables in a disclosed securable recycling receptacle. The method 300 begins with operation 302 and the lock 148 coupled to the securable recycling receptacle 100 may be unfastened or unlocked. For example, the lock 148 may be unlocked by a universal key 154. In some embodiments where the lock includes a combination, the lock may be unlocked by entering the correct combination. As discussed above, the lock 148 may be unlocked by an authorized operator, such as, for example, cannabis dispensary owners or employees, government authorities, and recycling service providers.

After operation 302, the method 300 may proceed to operation 304 and the lock 148 may be removed from the locking mechanism 108. For example, the lock 148 may be removed from the locking eye aperture 152 of the locking eye 146.

After operation 304, the method 300 may proceed to operation 306 and the lid 104 may be placed in an open position. The open position may be a partial, full, or complete open position. For example, the lid 104 may be opened past the hinge 142 so that it is not in the way of the opening to the housing cavity 120. The lid 104 may be opened manually (e.g., by lifting the lid 104 from the housing 102) or by pressing down on the foot pedal 156.

After operation 306, the method 300 may proceed to operation 308 and regulated recyclables may be removed from the housing cavity 120 of the securable recycling receptacle 100. As discussed, cannabis containers and/or other cannabis-related products may be removed from the housing cavity 120. In some embodiments, the housing cavity 120 includes an interior liner or bag that can be easily removed from the housing cavity 120 to remove the regulated recyclables contained therein. The regulated recyclables may be removed to transport them to a regulation-compliant recycling facility that recycles the regulated recyclables in compliance with laws and regulations (e.g., in compliance with cannabis consumer waste disposal laws and regulations).

After operation 308, the method 300 may proceed to operation 310 and the lid 104 may be placed in a closed position. For example, the lid 104 may be closed manually or by releasing the foot pedal 156.

After operation 310, the method 300 may proceed to operation 312 and the lock 148 may be coupled to the locking mechanism 108. For example, the lock 148 may be positioned partially within the locking eye aperture 152 of the locking eye 146.

After operation 312, the method 300 may proceed to operation 314 and the lock may be fastened or locked to secure the lid 104 to the housing 102 of the securable recycling receptacle 100 to prevent unauthorized access to the housing cavity 120. For example, the lock 148 may be locked by the universal key 154. In some embodiments where the lock includes a combination, the lock may be locked by entering the correct combination and changing the combination to an incorrect combination.

While the above method 300 describes a lock 148 that is removable from the securable recycling receptacle 100, it is contemplated that the lock may be coupled to the securable recycling receptacle 100 in a manner that enables the lock to fasten and unfasten the lid 104 without being removed. For example, the lock may include an internal latching mechanism that latches to fasten the lid 104 and unlatches to open the lid 104.

While various embodiments and examples described herein are directed to the cannabis industry and cannabis consumer waste, it is contemplated that the securable recycling receptacle may be configured to receive other regulated waste for other regulated or controlled substances. For example, the securable recycling receptacle may be used for waste related to other hemp-based products, such as CBD.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated and may include wired or wireless connections, including electrical connections. As such, connection references do not necessarily infer that two elements are directly connected and in fixed relation to each other. The exemplary drawings are for purposes of illustration only and the dimensions, positions, order, and relative sizes reflected in the drawings attached hereto may vary.

While certain orders of operations are provided for methods disclosed herein, it is contemplated that the operations may be performed in any order and that operations can be omitted, unless specified otherwise.

The above specification, examples and data provide a complete description of the structure and use of exemplary embodiments of the invention as defined in the claims. Although various embodiments of the claimed invention have been described above with a certain degree of particularity, or with reference to one or more individual embodiments, other embodiments of the present invention will become apparent to those skilled in the art from the detailed description and those skilled in the art could make numerous alterations to the disclosed embodiments without departing from the spirit or scope of the present invention. Other embodiments are therefore contemplated. It is intended that all matter contained in the above description and shown in the accompanying drawings shall be interpreted as illustrative only of particular embodiments and not limiting or restrictive. Changes in detail, structure, or composition may be made without departing from the basic elements of the invention as defined in the following claims.

We claim:

1.-12. (canceled)

13. A method of recycling a cannabis container, comprising:
locating a circular lid opening defined in a top surface of a lid of a securable recycling receptacle, wherein the circular lid opening has a diameter between 3.5 inches and 4 inches, wherein the diameter sizing permits a cannabis container to pass therethrough while preventing other larger sized non-cannabis containers and objects the size of an average adult hand from passing therethrough, and wherein:
the securable recycling receptacle comprises a housing, the housing defining a housing cavity accessible by the circular lid opening;
a first side of the lid is coupled to a first wall of the housing by a hinge;
a locking mechanism is coupled to a second side of the lid and a second wall of the housing to secure the lid to the housing and to prevent unauthorized access to one or more cannabis containers stored in the housing cavity; and
discarding the cannabis container through the circular lid opening and into the housing cavity, wherein the cannabis container was used to store cannabis.

14. The method of claim 13, wherein the method is compliant with U.S. state government regulations for recycling cannabis consumer waste.

15. The method of claim 13, wherein the diameter sizing of the circular lid opening allows passage of a maximum-sized cannabis container therethrough while limiting access to the housing cavity, wherein the maximum-sized cannabis container is defined by U.S. state government regulations on sizing of cannabis containers.

16. A method of accessing cannabis containers stored in a securable recycling receptacle, comprising:
unfastening a locking mechanism coupled to a housing of the securable recycling receptacle, wherein:
the locking mechanism secures a lid to the housing,
the housing defines a housing cavity storing the cannabis containers, and
the lid comprises a lid opening on a top surface of the lid that allows limited access to the housing cavity;
positioning the lid in an open position; and
removing the cannabis containers from the housing cavity for recycling at a regulation-compliant recycling facility,
wherein the method is compliant with U.S. state government cannabis consumer waste disposal laws and regulations.

17. The method of claim 16, wherein the lid is coupled to a first wall of the housing by a hinge and the locking mechanism is coupled to a second wall of the housing, wherein the first wall and the second wall are adjacent and connected walls.

18. The method of claim 17, wherein unfastening the locking mechanism comprises inserting a key inside a lock of the locking mechanism and turning the key, wherein the key is tethered to the first wall of the housing.

19. The method of claim 16, wherein the lid opening is sized to fit a maximum-sized cannabis container and to prevent objects larger than the maximum-sized cannabis container from passing therethrough, wherein the maximum-sized cannabis container is defined by U.S. state government regulations on sizing of cannabis containers.

20. The method of claim 16, wherein:
the locking mechanism comprises a lock, a latch, and a locking eye;
one of the latch and locking eye are coupled to the housing;
the latch is coupled to the locking eye;
the lock is positioned through a locking eye aperture of the locking eye,
the lock hangs at least partially below the locking eye and at least partially below the lid, and
unfastening the locking mechanism comprises unfastening the lock; and
the method further comprises:
removing the lock from the locking eye aperture after unfastening the lock; and
uncoupling the latch from the locking eye before positioning the lid in the open position.

21. The method of recycling regulated recyclables of claim 13, wherein the circular lid opening has a four inch diameter.

22. The method of recycling regulated recyclables of claim 13, wherein the first side of the lid is adjacent to the second side of the lid.

23. The method of recycling regulated recyclables of claim 13, wherein the first wall and the second wall are adjacent and connected walls, and wherein the locking mechanism comprises a locking eye and a lock coupled to the locking eye, wherein the lock hangs at least partially below the locking eye and at least partially below the lid and is configured to receive a key in a position below the lid.

24. The method of recycling regulated recyclables of claim 13, wherein the securable recycling receptacle further comprises a key coupled to the first wall of the housing by a tether, wherein the key is configured to unlock the locking mechanism and the tether has a length that enables the key to reach the locking mechanism.

25. The method of recycling regulated recyclables of claim 23, wherein the securable recycling receptacle further comprises:
a tether that is fixedly coupled to the first wall of the housing adjacent to the hinge; and
a key coupled to a distal end of the tether;
wherein the tether has a length that permits movement of the key to the position below the lid.

26. The method of recycling regulated recyclables of claim 13, wherein the locking mechanism comprises a key lock and the securable recycling receptacle further comprises a key coupled to the first wall by a tether, wherein the tether is fixedly coupled to the first wall and the key is fixedly coupled to the tether, and wherein the tether has a length that permits the key to unlock the key lock while the tether is fixedly coupled to the first wall.

27. The method of recycling regulated recyclables of claim 13, wherein the circular lid opening has a diameter between 3.75 inches and 4 inches.

28. The method of claim 16, wherein the lid opening is circular and has a diameter between 3.5 inches and 4 inches.

29. A method of using a securable recycling receptacle to comply with United States state government regulations related to disposal of regulated recyclables that are configured to hold one or more controlled substances, comprising:
locating the securable recycling receptacle, wherein the securable recycling receptacle comprises:
a housing comprising a front wall, a rear wall, a first sidewall, and a second sidewall, wherein the front wall and the rear wall are opposing walls and the first sidewall is positioned between and connected to the rear wall and the front wall, and wherein the housing defines a housing cavity;
a lid comprising a lid front wall, a lid rear wall, and a lid sidewall, wherein the lid rear wall is coupled to the rear wall by a hinge, and wherein the lid is configured to open and to provide access to the housing cavity by separating the lid front wall from the front wall;
a circular opening defined in a top surface of the lid, wherein the circular opening provides limited access to the housing cavity when the lid is in a closed position;
a key lock coupled to the first sidewall and the lid sidewall, wherein the key lock is configured to secure the lid to the housing to prevent unauthorized access to regulated recyclables stored inside the housing cavity, wherein a regulated recyclable is a container regulated by the United States government that is configured to hold a controlled substance, and wherein the controlled substance is defined by the United States government; and
a key coupled to the rear wall by a tether, wherein the tether is fixedly coupled to the rear wall and the key is fixedly coupled to the tether, wherein the tether is coupled to the rear wall in a position proximate to the hinge and between the hinge and the first sidewall, and wherein the tether is a length that permits the key to unlock the key lock while the tether is fixedly coupled to the rear wall; and
discarding a regulated recyclable through the circular opening.

30. The method of claim 29, wherein the circular opening has a diameter between 3.5 inches and 4 inches.

31. The method of claim 29, further comprising a cannabis container positioned inside the housing cavity.

32. The method of claim 29, wherein the regulated recyclable is a cannabis container that was used to store cannabis.
